(19) United States
(12) Patent Application Publication
(10) Pub. No.: US 2007/0082649 A1
(43) Pub. Date: Apr. 12, 2007

(54) Power line communication and AC power outlet apparatus and method

(75) Inventor: Tat Keung Chan, South San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Asoka USA Corporation, Foster City, CA (US)

(21) Appl. No.: 11/245,700

(22) Filed: Oct. 7, 2005

(51) Int. Cl. H04B 1/38

(52) U.S. Cl. 455/402; 455/90.3; 455/351

(57) ABSTRACT

In a specific embodiment, the present invention includes a power line communication apparatus, e.g., portable or secured. The apparatus has an enclosure having a mounting member and a face region. The mounting member has a first side and a second side. The apparatus has a powerline module coupled to the mounting member and is within an interior of the enclosure. The power line module is adapted to convert a data signal having a first format to a second format, which is capable of transmission to a power line network. The apparatus has a network processor coupled to the powerline module and is within the interior of the enclosure. The apparatus has a coupling device coupled to an input/output of the powerline module. The coupling device is coupled to the data signal. The apparatus also has at least a pair of power plug members extending from the second side of the enclosure. An Ethernet port is provided on a first portion of the face region and is coupled to the powerline module. The Ethernet port is used to transmit and receive the data signal in the first format. At least one female power outlet is provided on a second portion of the face. The female power outlet is coupled to the pair of power plug members.

### BACKGROUND OF THE INVENTION

The present invention relates generally to power line networking techniques. More particularly, the invention provides an apparatus for a high speed power line network using a power plug adapter for a computing environment. Merely by way of example, the invention has been applied in a local area network environment, but it would be recognized that other applications exist. The invention can also be applied to building area networking, home networking, office networking, apartments, any combination of these, and other networking applications.

Telecommunication techniques have been around for numerous years. In the early days, a communication technique known as telegraph was developed. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line. Most industrialized countries today rely heavily upon telephone to facilitate communication between businesses and people, in general.

In the 1990s, another significant development in the telecommunication industry occurred. People began communicating to each other by way of computers, which are coupled to the telephone lines or telephone network or other communication network. These computers or workstations coupled to each other can transmit many types of information from one geographical location to another geographical location. In general, there has been various types of computer networks, including local area networks, commonly called LANs, and wide are networks, commonly called WANs.

Local area networks have been used to connect computers in a smaller geographic region than wide area networks. Most local area networks rely upon dedicated cables to transmit the communication signals through the network. An alternative way of transmitting such communication signals through non-dedicated cables but through a power supply network is referred to as Power line Communication, commonly called PLC. Power line communication relies upon pre-existing power lines that are used to supply electrical power distributed through buildings, such as homes and office structures. Conventional PLC relies upon radio frequency technologies. Although power line communications have been successful in part, many limitations still exist.

For example, power line communication generally has limited capability due to lack of infrastructure. That is, power line networking has not been “mainstream,” Power line networking has little or almost no infrastructure. Additionally, power line network devices are lacking and simply do not exist on a wide scale. In conventional office settings in the United States, power line networking is absent and almost non-existent. These and other limitations have been described throughout the present specification and more particularly below.

From the above, it is seen that improved techniques for power line networks are highly desired.

### BRIEF SUMMARY OF THE INVENTION

According to the present invention, techniques for power line networking techniques are provided. More particularly, the invention provides an apparatus for a high speed power line network using a power plug adapter for a computing environment. Merely by way of example, the invention has been applied in a local area network environment, but it would be recognized that other applications exist. The invention can also be applied to building area networking, home networking, office networking, apartments, any combination of these, and other networking applications.

In a specific embodiment, the present invention includes a power line communication apparatus, e.g., portable or secured. The apparatus has an enclosure having a mounting member and a face region. The mounting member has a first side and a second side. The apparatus has a powerline module coupled to the mounting member and is within an interior of the enclosure. The power line module is adapted to convert a data signal having a first format to a second format, which is capable of transmission to a power line network. The apparatus has a network processor coupled to the powerline module and is within the interior of the enclosure. The apparatus has a coupling device coupled to an input/output of the powerline module. The coupling device is coupled to the data signal. The apparatus also has at least a pair of power plug members extending from the second side of the enclosure. An Ethernet port is provided on a first portion of the face region and is coupled to the powerline module. The Ethernet port is used to transmit and receive the data signal in the first format. At least one female power outlet is provided on a second portion of the face. The female power outlet is coupled to the pair of power plug members.

One or more benefits can be achieved using the present invention over conventional techniques. The present invention can be applied using conventional components from computer networking and hardware technologies. Additionally, the invention can be applied to pre-existing power line structures without substantial modification. Preferably, the present system and method are easy to implement and also allows for power line networking capabilities and power plug abilities using the same apparatus according to a specific embodiment. Depending upon the embodiment, one or more of these benefits may exist. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a power line system according to an embodiment of the present invention;

FIG. 2 is a simplified diagram of a power line gateway system according to an embodiment of the present invention;

FIG. 3 is a simplified block diagram of the power line gateway system of FIG. 2 according to a specific embodiment;

FIG. 4 is a simplified front view diagram of a power line and AC power outlet according to an embodiment of the present invention;

FIG. 5 is a simplified block diagram of a power line module for the power line and AC power outlet according to an embodiment of the present invention; and

FIGS. 6 through 8 are simplified diagrams illustrating an alternative power line and AC power outlet according to an embodiment of the present invention.

### DETAILED DESCRIPTION OF THE INVENTION

According to the present invention, techniques for power line networking techniques are provided. More particularly, the invention provides an apparatus for a high speed power line network using a power plug adapter for a computing environment. Merely by way of example, the invention has been applied in a local area network environment, but it would be recognized that other applications exist. The invention can also be applied to building area networking, home networking, office networking, apartments, any combination of these, and other networking applications.

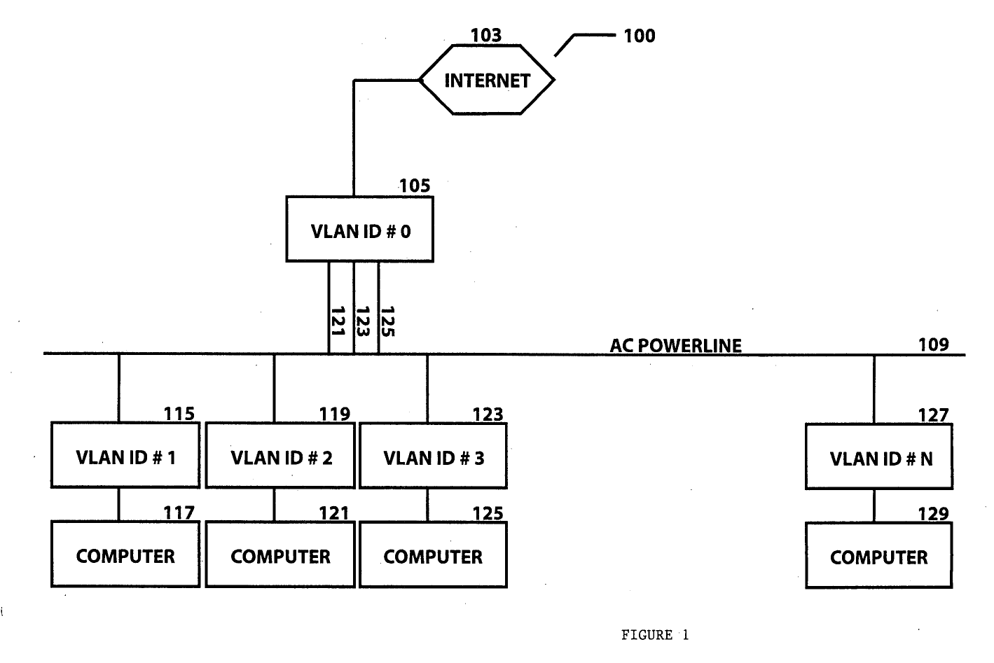

FIG. 1 is a simplified diagram of a power line system according to an embodiment of the present invention. This diagram is merely an example, which should not unduly limit the scope of the claims herein. One of ordinary skill in the art would recognize many variations, alternatives, and modifications. As shown, the system 100 for power line networking is included. The system 100 has an external data source 103, which is derived from a world wide networks of computers. As merely an example, the data source can be the Internet or other like entity. The system includes a first power line 121, a second power line 123, and a third power line 125, each of which corresponds to a phase. Each of the power lines is often bundled together and represented by reference numeral 111.

Referring again to FIG. 1, the system includes a gateway 115 coupled between the data source and an AC power line 109 according to a specific embodiment. The AC power line couples to a plurality of power line devices 115, 119, 123, 127 numbered from 1 through N, where N is an integer greater than 2, according to a specific embodiment. Each of the power line devices is coupled to a client device 117 or a plurality of client devices to define a “segment” on the power line network. As shown, power line device 119 couples to client device 121. Power line device 123 couples to client device 125. Power line device 127 couples to client device 129. Depending upon the specific embodiment, the client device can be a personal computer, a wireless device, a lap top computer, an Internet phone, an Internet appliance (e.g., refrigerator, stereo, television set, clock, digital paintings), any combinations of these, and others. Of course, one of ordinary skill in the art would recognize. Further details of the gateway and power line device can be found throughout the present specification and more particularly below.

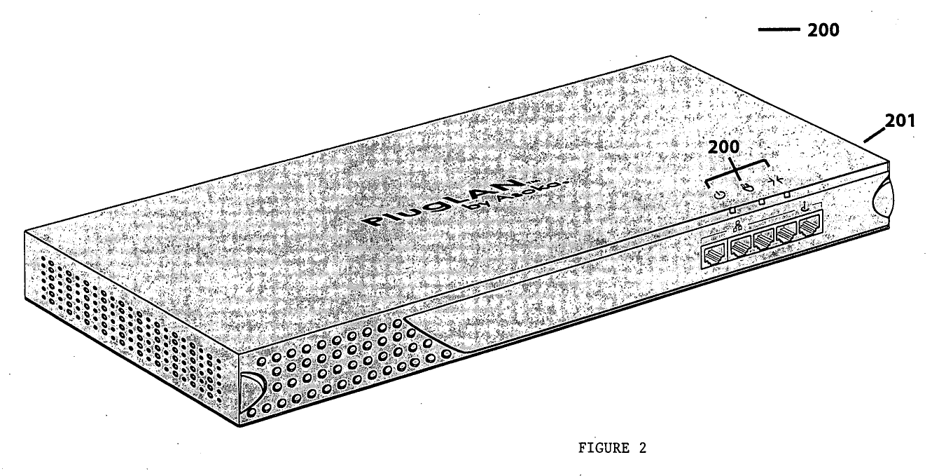

FIG. 2 is a simplified diagram of a power line gateway system 200 according to an embodiment of the present invention. This diagram is merely an example, which should not unduly limit the scope of the claims herein. One of ordinary skill in the art would recognize many variations, alternatives, and modifications. As shown, the gateway system 200 has a housing 201 including at least three input/output ports 205, which can be coupled to external power lines according to a specific embodiment. In a specific embodiment, one or more power line signals is derived from the housing.

In a preferred embodiment, the power line signal coupled to each of the three input/output ports. That is, the power line signal is injected directly into each of the phases. In a specific embodiment, the present power line signal is injected directly into each of the phases, where the phases are not coupled to each other upon injection according to a specific embodiment. The three input/output ports include a first phase input/output port coupled to the first power line, a second phase input/output port coupled to the second power line, and a third input/output port coupled to the third power line. Of course, there can be other variations, modifications, and alternatives. Further details of the gateway system can be found throughout the present specification and more particularly below.

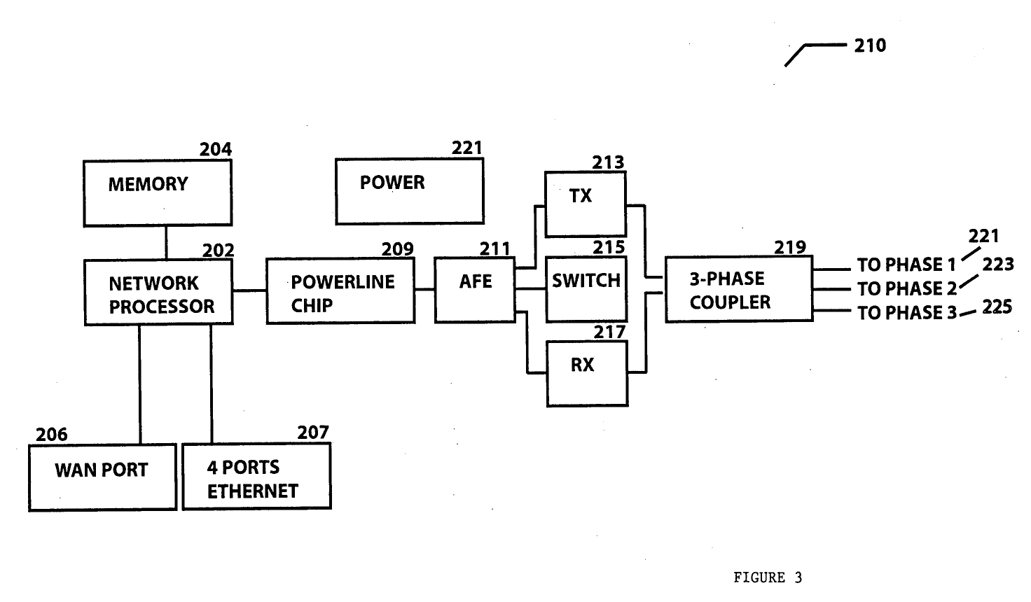

FIG. 3 is a simplified block diagram 210 of the power line gateway system of FIG. 2 according to a specific embodiment. This diagram is merely an example, which should not unduly limit the scope of the claims herein. One of ordinary skill in the art would recognize many variations, alternatives, and modifications. As shown, the system has a network processor 202 within the housing and coupled to the power line signal via power line chip 209. In a specific embodiment, the network processor includes a network connector input/output port 206 coupled the network processor and coupled to the housing. In a preferred embodiment, the input/output port 206 couples to a data network, which couples to a wide area network and/or world wide area network, as noted. The network processor also includes one or more input/output ports for one or more local area networks 207. The network processor has an interface to a memory device 204, which can include a dynamic random access memory, static random access memory, or other types, depending upon the specific embodiment. As merely an example, the network processor can be any suitable type such as the ADM5120 Series manufactured by Infineon Technologies AG of Germany, but can also be others. In a specific embodiment, the system also has a power module 221, which provides suitable power (e.g., voltage/current) to each of the elements described herein. Of course, one of ordinary skill in the art would recognize other variations, modifications, and alternatives.

In a preferred embodiment, the system has the power line chip 209, called herein “PLC” chip, which is coupled between the network processor and analog front end 211 device. As shown, the PLC is coupled to the analog front end (AFE) module 211. The AFE module interfaces between the chipset and a three phase coupler 219 according to a specific embodiment. Between the AFE and coupler is transmit 213 and receive 217 devices according to a specific embodiment. A switching device couples to the AFE chip and transmit device according to a specific embodiment. Further details of the power line chip, AFE, TX/RX devices, and coupler are provided throughout the present specification and more particularly below.

In a specific embodiment, the power line device can be any suitable power line integrated circuit chips and/or chip sets. As merely an example, the power line chip is an integrated circuit chip sold under part number 5500CS manufactured by INTELLON CORPORATION of Florida. Here, the chip can be a single-chip power line networking controller with integrated MII/GPSI, USB. The chip interfaces with Ethernet interfaces, among others. Preferably, there is at least a 80 Mbps data rate on the power line, although others may desirable. Additional features include an Integrated 10-bit ADC, 10-bit DAC and AGC, a selectable MDI/SPI PHY management interface, general purpose 8-wire serial PHY data interface. Preferably, the signal processing uses Orthogonal Frequency Division Multiplexing (OFDM) for high data reliability, as well as adaptive channel characterization, Viterbi and block coding. In alternative embodiments, the power line device can also include other chip designs that are suitable for the present methods and systems. Of course, one of ordinary skill in the art would recognize other variations, modifications, and alternatives.

In a specific embodiment, the three phase coupler can be any suitable device capable of injecting power line signals directly into each of the three phases 221, 223, 225 independently. In a specific embodiment, ,the coupler can be an inductive coupler and/or capacitive coupler, but may be others. In a preferred embodiment, each of the three phases receives/transmits power line signals directly (and are not coupled to each other at the gateway or within a vicinity of the gateway) to more efficient signal transfer and receive processes. As merely an example, the coupler can be either inductive and/or capacitive, but can be others. As noted, the three phase coupler is merely an example and should not unduly limit the scope of the claims herein.

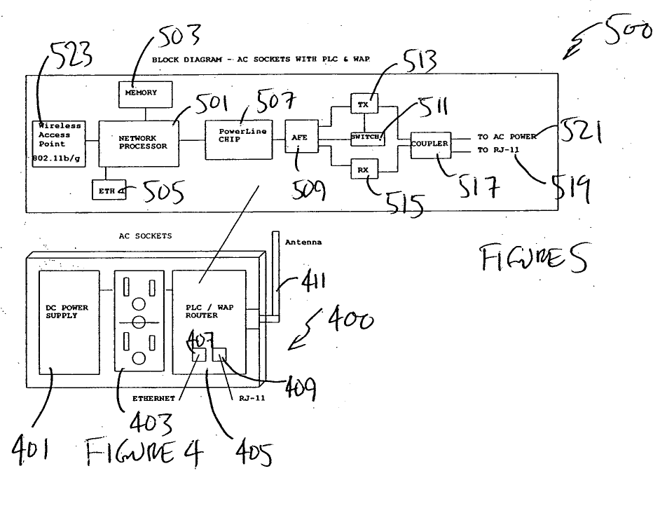

FIG. 4 is a simplified diagram of a power line apparatus 400 according to an embodiment of the present invention. This diagram is merely an example, which should not unduly limit the scope of the claims herein. One of ordinary skill in the art would recognize many variations, alternatives, and modifications. As shown, the apparatus can be provided in housing 400, which is adapted to a wall or other like structure according to a specific embodiment. As shown, the housing includes a power line device, which is provided in a module will be further described throughout the present specification and more particularly below.

The powerline device is coupled to input/outputs. Such input/outputs include an RJ-11-type connector 409, an Ethernet connector 407, and others, if desired. The Ethernet connector often associated with a CAT 5-type connector. Each of these can be provided on a face plate of the apparatus. Of course, the connectors can also be provided on other spatial locations of the apparatus. The apparatus also includes one or more power outlets 403, commonly termed AC outlets. The AC outlets are provided for AC power to any electronic devices that require such AC power. The housing also has a DC power supply that provides power to the module. In a specific embodiment, the housing also includes a wireless antenna, which is coupled to the module. The module includes a wireless device coupled to the antenna. Each of these elements is provided within the housing, which includes at least a pair of power plugs to be inserted into an AC power outlet provided in a power line network according to a specific embodiment. Further details of the housing can be found throughout the present specification and more particularly below.

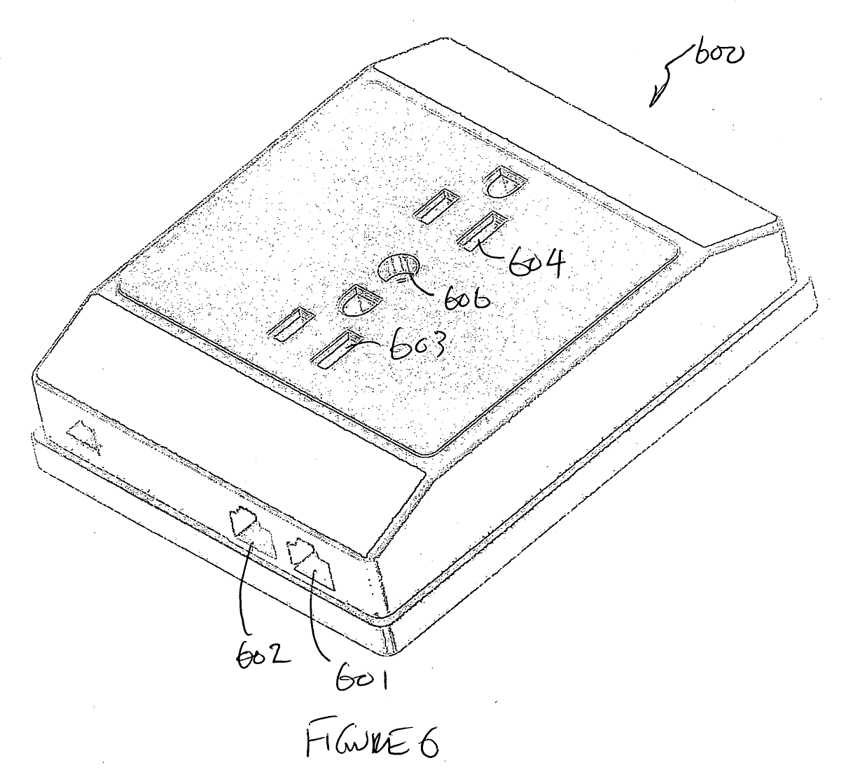

FIG. 5 is a simplified block diagram of a power line module provided in the housing according to an embodiment of the present invention. This diagram is merely an example, which should not unduly limit the scope of the claims herein. One of ordinary skill in the art would recognize many variations, alternatives, and modifications. In a preferred embodiment, the module is provided within a interior region of the housing. As shown, the module has a network processor 501 within the housing and coupled to the power line signal via power line chip 507. In a specific embodiment, the network processor includes one or more input/output ports for one or more local area networks via line or lines 521. In a specific embodiment, the local area network can be Ethernet and/or other like technology. The network processor has an interface to a memory device 505, which can include a dynamic random access memory, static random access memory, or other types, depending upon the specific embodiment. As merely an example, the network processor can be any suitable type such as the ADM5120 Series manufactured by Infineon Technologies AG of Germany, but can also be others. Of course, one of ordinary skill in the art would recognize other variations, modifications, and alternatives.

In a preferred embodiment, the system has the power line chip 507, called herein “PLC” chip, which is coupled between the network processor and an analog front end 509 device. As shown, the PLC is coupled to the analog front end (AFE) device and/or module. The AFE module interfaces between the PLC chip and a phase coupler 519 according to a specific embodiment. Between the AFE and coupler is transmit 513 and receive 515 devices according to a specific embodiment. A switching device 511 couples to the AFE chip and transmit device according to a specific embodiment. Further details of the power line chip, AFE, TX/RX devices, and coupler are provided throughout the present specification and more particularly below.

In a specific embodiment, the power line device can be any suitable power line integrated circuit chips and/or chip sets. As merely an example, the power line chip is an integrated circuit chip sold under part number 5500CS manufactured by INTELLON CORPORATION of Florida. Here, the chip can be a single-chip power line networking controller with integrated MII/GPSI, USB. The chip interfaces with Ethernet interfaces 505, among others. Preferably, there is at least a 80 Mbps data rate on the power line, although others may desirable. Additional features include an Integrated 10-bit ADC, 10-bit DAC and AGC, a selectable MDI/SPI PHY management interface, general purpose 8-wire serial PHY data interface. Preferably, the signal processing uses Orthogonal Frequency Division Multiplexing (OFDM) for high data reliability, as well as adaptive channel characterization, Viterbi and block coding. In alternative embodiments, the power line device can also include other chip designs that are suitable for the present methods and systems. Of course, one of ordinary skill in the art would recognize other variations, modifications, and alternatives.

In a specific embodiment, the coupler 517 can be any suitable device capable of injecting and/or receiving power line signals to and/from a power line, which is coupled to a power line network. In a specific embodiment, ,the coupler can be an inductive coupler and/or capacitive coupler, but may be others. As merely an example, the coupler (either inductive and/or capacitive coupler), but can be others. The coupler couples to AC power line 521, which is provided on the powerline network. Additionally, the coupler or other coupling device is coupled to an RF-11 outlet 519 for telephone communication. Of course, there can be many variations, modifications, and alternatives.

In a specific embodiment, the network processor is also coupled to wireless access point device 523. The wireless access point device can be any suitable integrated circuit chip and/or chips, including modules, according to a specific embodiment. The wireless access point device can be an 802.11-type device or other type of wireless transmission/receive device according to a specific embodiment. The wireless access device is coupled to the wireless antenna according to a specific embodiment. Of course, there can be other variations, modifications, and alternatives.

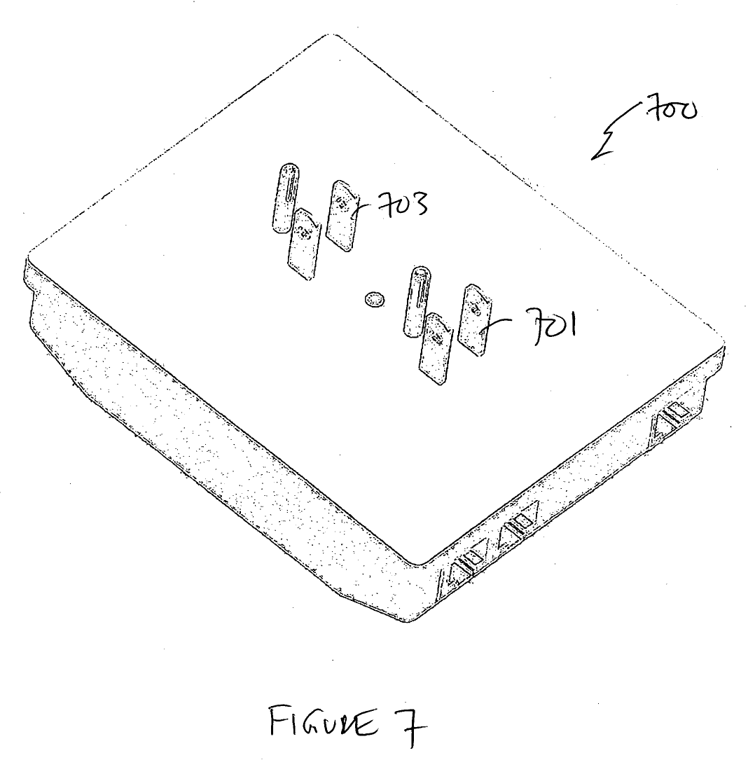

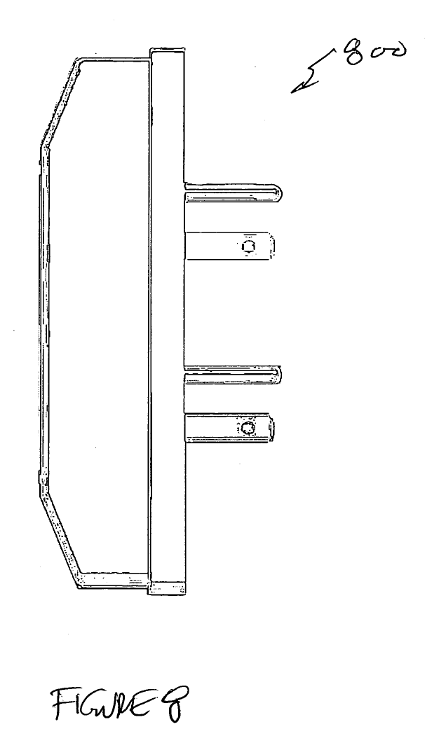

FIGS. 6 through 8 are simplified diagrams illustrating an alternative power line and AC power outlet according to an embodiment of the present invention. These diagrams are merely examples, which should not unduly limit the scope of the claims herein. One of ordinary skill in the art would recognize many variations, modifications, and alternatives. As shown, the outlet 600 includes a plurality of AC outlets 604, 604 provided on a face portion of an enclosure according to a specific embodiment. The enclosure also includes a plurality of Ethernet ports 601, 602, which couple to cabling for networking applications. Referring now to FIG. 7, the enclosure 700 includes a plurality of power plugs 701, 703, which are inserted into an AC wall socket or the like according to a specific embodiment. A side view diagram 800 is also illustrated.

In a specific embodiment, the housing has a center region 606 is a screw opening or hole that will be used to permanently mount the enclosure onto the AC wall socket according to a specific embodiment. That is, a screw is inserted into the opening and secures the enclosure once it has been inserted into the AC wall socket. The enclosure can include the powerline module, which has been previously described according to a specific embodiment. Of course, there can be other variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A portable power line communication apparatus, the power line communication apparatus comprising:
an enclosure having a mounting member and a face region, the mounting member having a first side and a second side;
a powerline module coupled to the mounting member and within an interior of the enclosure, the power line module being adapted to convert a data signal having a first format to a second format, the second format being capable of transmission to a power line network;
a network processor coupled to the powerline module and within the interior of the enclosure;
a coupling device coupled to an input/output of the powerline module, the coupling device being coupled to the data signal, the coupling device within the interior of the enclosure;
at least a pair of power plug members extending from the second side of the enclosure, the pair of power plug members being coupled to the coupling device;
an Ethernet port provided on a first portion of the face region, the Ethernet port being coupled to the powerline module and adapted to transmit and receive the data signal in the first format; and
at least one female power outlet provided on a second portion of the face, the female power outlet being coupled to the pair of power plug members.

2. Apparatus of claim 1 wherein the enclosure comprises a plastic housing.

3. Apparatus of claim 1 wherein the at least one female power outlet includes a pair of power outlets, the power of power outlets being adapted to receive two independent power plugs.

4. Apparatus of claim 1 wherein the power line module comprises a power line chip coupled to a network processing device.

5. Apparatus of claim 1 wherein the power line module comprises a power line chip coupled to a network processing device and a memory device coupled to the network processor.

6. Apparatus of claim 1 wherein the mounting member is provided on a backside of the enclosure.

7. Apparatus of claim 1 further comprising a wireless transmission device coupled to the network processor, the wireless transmission device being within the interior of the enclosure.

8. Apparatus of claim 7 further comprising an antenna coupled to a third portion of the face.

9. Apparatus of claim 1 further comprising an attachment region provided through a fourth portion of the face.

10. Apparatus of claim 1 wherein the data signal in the second format is an OFDM format.

11. Apparatus of claim 1 wherein the power line module comprises a power line chip coupled to an analog front end.
